(19) United States
(12) Patent Application Publication
(10) Pub. No.: US 2021/0234199 A1
(43) Pub. Date: Jul. 29, 2021

(54) NON-AQUEOUS LIQUID ELECTROLYTE COMPOSITION

(71) Applicant: SOLVAY SA, Brussels (BE)

(72) Inventors: Ji-Hye WON, Seoul (KR); Moon-Hyung CHOI, Seoul (KR); Mi-Soon OH, Seoul (KR); Hyun-Cheol LEE, Gyeonggi-do (KR); Lawrence Alan HOUGH, Seoul (KR); Hae-Young KIM, Seoul (KR)

(21) Appl. No.: 17/051,086

(22) PCT Filed: May 2, 2019
(86) PCT No.: PCT/EP2019/061188

§ 371 Date: Oct. 27, 2020

(30) Foreign Application Priority Data
May 4, 2018 (EP) 18170730.8

(51) Int. Cl. H01M 10/0567; H01M 10/0569; H01M 10/0525

(52) U.S. Cl. CPC H01M 10/0567; H01M 10/0569; H01M 2300/004; H01M 2300/0034; H01M 10/0525

(57) ABSTRACT

This invention relates to a non-aqueous liquid electrolyte composition suitable for secondary battery cells, especially lithium-ion secondary battery cells. Such electrolyte composition comprises a) at least one non-fluorinated cyclic carbonate and at least one fluorinated cyclic carbonate, b) at least one fluorinated acyclic carboxylic acid ester, c) at least one electrolyte salt, d) at least one lithium borate compound, e) at least one cyclic sulfur compound, and f) optionally at least one cyclic carboxylic acid anhydride, all components being present in specific proportions. It can advantageously be used in batteries comprising a cathode material comprising a lithium nickel manganese cobalt oxide (NMC) or a lithium cobalt oxide (LCO), especially at a high operating voltage.

### TECHNICAL FIELD AND BACKGROUND

This invention relates to a particular non-aqueous liquid electrolyte composition suitable for secondary battery cells, especially lithium-ion secondary battery cells. It can advantageously be used in batteries comprising a cathode material comprising a lithium nickel manganese cobalt oxide (NMC) or a lithium cobalt oxide (LCO), especially at a high operating voltage.

In connection with NMC batteries, a high operating voltage can be defined as a voltage of at least 4.3V and preferably not more than 4.4V, whereas a conventional operating voltage is inferior to 4.3V.

In connection with LCO batteries, a high operating voltage can be defined as a voltage of at least 4.4V and preferably not more than 4.5V, whereas a conventional operating voltage is inferior to 4.4V.

NMC and LCO batteries are two well-known types of batteries that can be used for various applications. For instance, NMC batteries are useful in electric vehicles and energy storage systems (ESS) whereas LCO batteries are particularly suitable for portable electronic devices, such as mobile phones, laptop computers, and cameras.

Either in the field of LCO batteries or in the field of NMC batteries, exploring high operating voltage space is currently challenging. Regarding electrolyte compositions available on the market, most of them decompose at high operating voltages, resulting in undesirable by-products which deteriorate the electrochemical properties of the battery and therefore its stability. Particularly, the decomposition of the electrolyte composition may be induced by its oxidation which generates gases. The gas generation induces a swelling of the battery (also called “bulging”), which is an issue because it leads to a dislocation of components (e.g. anode+separator+cathode) of the battery. For instance, the contact between a negative electrode and a separator sheet, or the contact between a positive electrode and a separator sheet, can be broken. In an extreme case, the battery can burst, which results in a safety issue. Other issues of the known electrolyte compositions are their poor performances in terms of reversible capacity, storage stability due to their high sensitivity to temperature changes and/or cycle performance at high operating voltage.

It is therefore an object of the present invention to provide a non-aqueous liquid electrolyte composition that is especially suitable for a NCM and/or LCO battery operating at conventional or high voltage. It is in particular an object of the present invention to provide an electrolyte composition that is safe, that is stable upon storage at high temperature (such as 45° C. or 60° C.), that provides said battery a good cycle life and/or a good reversible capacity, even when operated at high voltage.

### SUMMARY OF THE INVENTION

This objective is achieved by providing a non-aqueous liquid electrolyte composition as defined in the claims.

In a first aspect, the present invention concerns a non-aqueous liquid electrolyte composition (hereinafter referred to as the electrolyte composition) comprising or consisting of:
a) from 5% to 17% of a non-fluorinated cyclic carbonate, and from 0.5% to 10% of a fluorinated cyclic carbonate,
b) from 70% to 95% of a fluorinated acyclic carboxylic acid ester,
c) at least one electrolyte salt,
d) from 0.1% to 5% of a lithium boron compound,
e) from 0.2% to 10% of a cyclic sulfur compound, and
f) optionally at least one cyclic carboxylic acid anhydride,
   all percentages being expressed by weight relative to the total weight of the electrolyte composition.

Said electrolyte composition shows improved electrochemical properties, in particular when implemented in a NCM and/or LCO battery operating at conventional of high voltage. It demonstrates improved reversible capacity, storage capacity, and/or cycle performance in comparison of the electrolytes compositions known in the art. The electrolyte composition according to the present invention especially allows achieving an unexpected and considerable improvement of both the energy density and the safety of a liquid electrolyte-based secondary battery suitable to operate at high voltage. It has been observed that the electrolyte composition according to the invention exhibits a great stability and enables an increase of the upper cut-off voltage of a high voltage battery, leading to an enhancement of both the energy density and the safety of said battery.

The term “electrolyte composition” as used herein, refers to a non-aqueous liquid chemical composition suitable for use as an electrolyte in an electrochemical cell.

The term “electrolyte salt” as used herein, refers to an ionic salt that is at least partially soluble in the electrolyte composition and that at least partially dissociates into ions in the electrolyte composition to form a conductive electrolyte composition.

The term “cyclic carbonate” as used herein refers specifically to an organic carbonate, wherein the organic carbonate is a dialkyl diester derivative of carbonic acid, the organic carbonate having a general formula R′OC(O)OR″, wherein R′ and R″ form a cyclic structure via interconnected atoms and are each independently selected from alkyl groups having at least one carbon atom, wherein R′ and R″ can be the same or different, branched or unbranched, saturated or unsaturated, substituted or unsubstituted.

Particular examples of branched or unbranched alkyl groups that can be used in accordance with the invention include methyl, ethyl, n-propyl, isopropyl, n-butyl, isobutyl, tert-butyl.

The term “fluorinated acyclic carboxylic acid ester” refers to a dialkyl carboxylic acid ester wherein the alkyl groups do not form a cyclic structure via interconnected atoms and wherein at least one hydrogen atom in the structure is substituted by fluorine. The alkyl groups are independently selected from alkyl groups having at least one carbon atom, they can be the same or different, branched or unbranched, saturated or unsaturated.

More generally, the term “fluorinated” in connection with any organic compound mentioned hereinafter means that at least one hydrogen is replaced by fluorine. The term “fluoroalkyl, fluoroalkenyl and fluoroalkynyl groups” refers to alkyl, alkenyl and alkynyl groups wherein at least one hydrogen is replaced by fluorine respectively.

The term “lithium phosphate compound” refers to a compound having both lithium and a phosphate group in the empirical formula. The lithium and phosphate group are not necessarily bonded directly to one another, but are present in the same compound.

The term “lithium boron compound” refers to a compound having both lithium and boron, preferably borate group, in the empirical formula. The lithium and boron or borate group are not necessarily bonded directly to one another, but are present in the same compound.

The term “lithium sulfonate compound” refers to a compound having both lithium and a sulfonate group in the empirical formula. The lithium and sulfonate group are not necessarily bonded directly to one another, but are present in the same compound.

The term “cyclic sulfur compound” commonly refers to an organic cyclic sulfate or sultone, being a dialkyl (di)ester derivative of sulphuric acid or sulfonic acid, wherein the alkyl groups form a cyclic structure via interconnected atoms and are each independently selected from alkyl groups having at least one carbon atom, that can be the same or different, branched or unbranched, saturated or unsaturated, substituted or unsubstituted.

The term “cyclic carboxylic acid anhydride” refers to an organic compound derived from a carboxylic acid wherein two acyl groups are bonded to an oxygen atom according to the general formula RₑC(O)—O—C(O)R_{f} and wherein Rₑ and R_{f} form a cyclic structure via interconnected atoms and are each independently selected from alkyl groups having at least one carbon atom, wherein Rₑ and R_{f} can be the same or different, branched or unbranched, saturated or unsaturated, substituted or unsubstituted.

In the following description, the expression “ranging from . . . to . . . ” should be understood as including the limits.

### SUMMARY OF THE FIGURES

FIG. 1 shows the retention capacity (in %) at 45° C. of the cells of examples 9, 10 and 11, as a function of the number of cycles.

### DETAILED DESCRIPTION

In the following detailed description, preferred embodiments are described in detail to enable practice of the invention. Although the invention is described with reference to these specific preferred embodiments, it will be understood that the invention is not limited to these preferred embodiments.

The electrolyte composition according to the present invention comprises at least one non-fluorinated cyclic carbonate and at least one fluorinated cyclic carbonate.

A cyclic carbonate may be represented by one of the formulas (I) or (II):

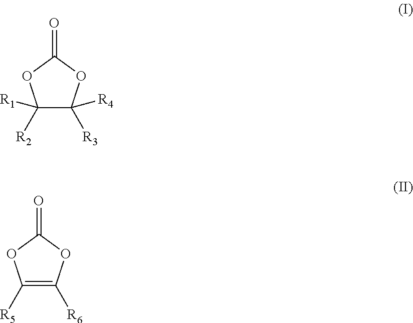

wherein R₁ to R₆, which may be the same or different, are independently selected from hydrogen, fluorine, a C1 to C8 alkyl group, a C2 to C8 alkenyl group, a C2 to C8 alkynyl group, a C1 to C8 fluoroalkyl group, a C2 to C8 fluoroalkenyl group, or a C2 to C8 fluoroalkynyl group.

Preferably, R₁ to R₆ are independently selected from hydrogen, fluorine, a C1 to C3 alkyl group, a C2 to C3 alkenyl group, a C2 to C3 alkynyl group, a C1 to C3 fluoroalkyl group, a C2 to C3 fluoroalkenyl group, or a C2 to C3 fluoroalkynyl group.

More preferably, R₁ and R₅ are independently selected from fluorine or a C1 to C3 alkyl group, said C1 to C3 alkyl group being preferably a methyl group, and R₂, R₃ R₄ R₆ are as defined above.

Even more preferably, R₁ and R₅ are independently selected from fluorine or a methyl group and R₂, R₃ R₄ R₆ are respectively hydrogen.

The non-fluorinated cyclic carbonate can be of the above formula (I) or (II) wherein, R₁ to R₆, which may be the same or different, are independently selected from hydrogen, a C1 to C8 alkyl group, a C2 to C8 alkenyl group, or a C2 to C8 alkynyl group.

Preferably, when the electrolyte composition according to the invention comprises a non-fluorinated cyclic carbonate of formula (I) or (II), R₁ to R₆ are independently selected from hydrogen, a C1 to C3 alkyl group, a C2 to C3 alkenyl group, or a C2 to C3 alkynyl group.

More preferably, when the electrolyte composition according to the invention comprises a non-fluorinated cyclic carbonate of formula (I) or (II), R₁ and R₅ are independently selected from hydrogen or a C1 to C3 alkyl group, said C1 to C3 alkyl group being preferably a methyl group, and R₂, R₃, R₄, R₆ are independently selected from hydrogen, a C1 to C3 alkyl group or a vinyl group.

Even more preferably, when the electrolyte composition according to the invention comprises a non-fluorinated cyclic carbonate of formula (I) or (II), R₁ and R₅ are independently a methyl group and R₂, R₃, R₄, R₆ are respectively hydrogen.

In a preferred sub-embodiment, said non-fluorinated cyclic carbonate is a non-fluorinated cyclic carbonate of formula (I) as defined above.

In another preferred sub-embodiment, the electrolyte composition according to the invention comprises at least two cyclic carbonates, preferably both of formula (I), at least one of the two being a non-fluorinated cyclic carbonate as defined above.

The non-fluorinated cyclic carbonate can be especially selected from ethylene carbonate, propylene carbonate, vinylene carbonate, ethyl propyl vinylene carbonate, vinyl ethylene carbonate, dimethylvinylene carbonate, and mixtures thereof. More preferably, it is selected from ethylene carbonate, propylene carbonate, vinyl ethylene carbonate, and mixtures thereof. Propylene carbonate is particularly preferred.

Non-fluorinated cyclic carbonates are commercially available (e.g. from Sigma-Aldrich) or can be prepared using methods known in the art. It is desirable to purify the non-fluorinated cyclic carbonate to a purity level of at least about 99.0%, for example at least about 99.9%. Purification can be done using methods known in the art. For example, propylene carbonate can be synthesized with a high purity according to the method described in U.S. Pat. No. 5,437,775.

Said non-fluorinated cyclic carbonate is present in the electrolyte composition in an amount ranging from 5%, preferably from 10%, more preferably from 12%, more preferably from 15%, to a maximum amount of 17%, by weight relative to the total weight of the electrolyte composition.

The fluorinated cyclic carbonate can be of the above formula (I) or (II), wherein at least one of R₁ to R₆ is fluorine, a C1 to C8 fluoroalkyl group, a C2 to C8 fluoroalkenyl group, or a C2 to C8 fluoroalkynyl group.

Preferably, when the electrolyte composition according to the invention comprises a fluorinated cyclic carbonate of formula (I) or (II), at least one of R₁ to R₆ is fluorine, a C1 to C3 fluoroalkyl group, a C2 to C3 fluoroalkenyl group, or a C2 to C3 fluoroalkynyl group.

More preferably, when the electrolyte composition according to the invention comprises a fluorinated cyclic carbonate of formula (I) or (II), R₁ and R₅ are independently fluorine and R₂, R₃, R₄, R₆ are independently selected from hydrogen, fluorine or a C1 to C3 alkyl group being preferably a methyl group.

Even more preferably, when the electrolyte composition according to the invention comprises a fluorinated cyclic carbonate of formula (I) or (II), R₁ and R₅ are independently fluorine and R₂, R₃, R₄, R₆ are respectively hydrogen.

In a preferred sub-embodiment, said fluorinated cyclic carbonate is a fluorinated cyclic carbonate of formula (I) as defined above.

The fluorinated cyclic carbonate can be especially selected from 4-fluoro-1,3-dioxolan-2-one; 4-fluoro-4-methyl-1,3-dioxolan-2-one; 4-fluoro-5-methyl-1,3-dioxolan-2-one; 4-fluoro-4,5-dimethyl-1,3-dioxolan-2-one; 4,5-difluoro-1,3-dioxolan-2-one; 4,5-difluoro-4-methyl-1,3-dioxolan-2-one; 4,5-difluoro-4,5-dimethyl-1,3-dioxolan-2-one; 4,4-difluoro-1,3-dioxolan-2-one; 4,4,5-trifluoro-1,3-dioxolan-2-one; 4,4,5,5-tetrafluoro-1,3-dioxolan-2-one; and mixtures thereof; 4-fluoro-1,3-dioxolan-2-one is particularly preferred.

Fluorinated cyclic carbonates are commercially available (4-fluoro-1,3-dioxolan-2-one especially can be obtained from Solvay) or can be prepared using methods known in the art, for instance such as described in WO2014056936. It is desirable to purify the fluorinated cyclic carbonate to a purity level of at least about 99.0%, for example at least about 99.9%. Purification can be done using methods known in the art.

The composition comprises at least two cyclic carbonates. At least one is a non-fluorinated cyclic carbonate and at least one is a fluorinated cyclic carbonate as described above.

The fluorinated cyclic carbonate is present in the electrolyte composition in an amount ranging from 0.5% to 10%, preferably from 0.8% to 10%, more preferably from 1% to 10%, more preferably from 2% to 10%, even more preferably from 3% to 10%, by weight relative to the total weight of the electrolyte composition.

The electrolyte composition according to the present invention also comprises at least a fluorinated acyclic carboxylic acid ester.

According to an embodiment, the fluorinated acyclic carboxylic acid ester is of formula:

R¹—COO—R²

wherein
i) R¹ is hydrogen, an alkyl group or a fluoroalkyl group;
ii) R² is an alkyl group or a fluoroalkyl group;
iii) either or both of R¹ and R² comprises fluorine; and
iv) R¹ and R², taken as a pair, comprise at least two carbon atoms but not more than seven carbon atoms.

In a sub-embodiment, R¹ and R² are as defined herein above, and R¹ and R², taken as a pair, comprise at least two carbon atoms but not more than seven carbon atoms and further comprise at least two fluorine atoms, with the proviso that neither R¹ nor R² contains a FCH2- group or a —FCH— group.

In a sub-embodiment, R¹ is hydrogen and R² is a fluoroalkyl group.

In a sub-embodiment, R¹ is an alkyl group and R² is a fluoroalkyl group.

In a sub-embodiment, R¹ is a fluoroalkyl group and R² is an alkyl group.

In a sub-embodiment, R¹ is a fluoroalkyl group and R² is a fluoroalkyl group, and R¹ and R² can be either the same as or different from each other.

Preferably, the number of carbon atoms in R¹ is 1 to 5, preferably 1 to 3, still preferably 1 or 2, even more preferably 1.

Preferably, the number of carbon atoms in R² is 1 to 5, preferably 1 to 3, still preferably 2.

Preferably, R¹ is hydrogen, a C1 to C3 alkyl group or a C1 to C3 fluoroalkyl group, more preferably a C1 to C3 alkyl group and still preferably a methyl group.

Preferably, R² is a C1 to C3 alkyl group or a C1 to C3 fluoroalkyl group, more preferably a C1 to C3 fluoroalkyl group and still preferably a C1 to C3 fluoroalkyl group comprising at least two fluorine atoms.

Preferably, neither R¹ nor R² contain a FCH2- group or a —FCH— group.

Said fluorinated acyclic carboxylic acid ester can especially be selected from the group consisting of 2,2-difluoroethyl acetate, 2,2,2-trifluoroethyl acetate, 2,2-difluoroethyl propionate, 3,3-difluoropropyl acetate, 3,3-difluoropropyl propionate, methyl 3,3-difluoropropanoate, ethyl 3,3-difluoropropanoate, ethyl 4,4-difluorobutanoate, difluoroethyl formate, trifluoroethyl formate, and mixtures thereof. Said fluorinated acyclic carboxylic acid ester can more preferably be selected from the group consisting of 2,2-difluoroethyl acetate, 2,2-difluoroethyl propionate, 2,2,2-trifluoroethyl acetate, 2,2-difluoroethyl formate and mixtures thereof; 2,2-difluoroethyl acetate is particularly preferred.

Fluorinated acyclic carboxylic acid esters can be purchased from a specialty chemical company or prepared using methods known in the art. For example, 2,2-difluoroethyl acetate can be prepared from acetyl chloride and 2,2-difluoroethanol, with or without a basic catalyst. Additionally, 2,2-difluoroethyl acetate and 2,2-difluoroethyl propionate may be prepared using the method described by Wiesenhofer et al. in WO2009/040367, Example 5. Other fluorinated acyclic carboxylic acid esters may be prepared using the same method using different starting carboxylate salts. Alternatively, some of these fluorinated solvents may be purchased from companies such as Matrix Scientific (Columbia S.C.).

It is desirable to purify the fluorinated acyclic carboxylic acid ester to a purity level of at least about 99.0%, for example at least about 99.9%. Purification can be done using methods known in the art, in particular distillation methods such as vacuum distillation or spinning band distillation.

The fluorinated acyclic carboxylic acid ester is present in the electrolyte composition in an amount ranging from a minimum amount of 70%, to a maximum amount of 95%, preferably to a maximum amount of 80%, more preferably to a maximum amount of 75%, by weight relative to the total weight of the electrolyte composition.

The electrolyte composition according to the invention also comprises at least one electrolyte salt, being preferably a lithium salt.

Suitable electrolyte salts include, without limitation, lithium hexafluorophosphate (LiPF₆), lithium bis(trifluromethyl)tetrafluorophosphate (LiPF₄(CF₃)₂), lithium bis(pentafluoroethyl)tetrafluorophosphate (LiPF₄(C₂F₅)₂), lithium tris(pentafluoroethyl)trifluorophosphate (LiPF₃(C₂F₅)₃), lithium bis(trifluoromethanesulfonyl)imide (LiN(CF₃SO₂)₂), lithium bis(perfluoroethanesulfonyl)imide LiN(C₂F₅SO₂)₂, LiN(C₂F₅SO₃)₂, lithium (fluorosulfonyl) (nonafluorobutanesulfonyl)imide, lithium bis(fluorosulfonyl)imide, lithium tetrafluoroborate, lithium perchlorate, lithium hexafluoroarsenate, lithium hexafluoroantimonate, lithium tetrachloroaluminate, lithium aluminate (LiAlO4), lithium trifluoromethanesulfonate, lithium nonafluorobutanesulfonate, lithium tris(trifluoromethanesulfonyl)methide, lithium bis(oxalato)borate, lithium difluoro(oxalato)borate, Li₂B₁₂F₁₂₋ₓHₓ where x is an integer equal to 0 to 8, and mixtures of lithium fluoride and anion receptors such as B(OC₆F₅)₃.

Mixtures of two or more of these or comparable electrolyte salts may also be used.

The electrolyte salt is preferably selected from lithium hexafluorophosphate, lithium bis(fluorosulfonyl)imide, lithium bis(trifluoromethanesulfonyl)imide and mixtures thereof. The electrolyte salt is more preferably selected from lithium hexafluorophosphate, lithium bis(fluorosulfonyl)imide and mixtures thereof. The electrolyte salt is most preferably lithium hexafluorophosphate.

The electrolyte salt is usually present in the electrolyte composition in an amount ranging from 5% to 20%, preferably from 6% to 18%, more preferably from 8% to 17%, more preferably from 9% to 16%, even more preferably from 11% to 16%, in weight relative to the total amount of electrolyte composition.

Electrolyte salts are commercially available (they can be purchased from a specialty chemical company such as Sigma-Aldrich or Solvay for lithium bis(trifluoromethanesulfonyl)imide) or can be prepared using methods known in the art. LiPF6 can for instance be manufactured according to the method described in U.S. Pat. No. 5,866,093. Sulfonylimides salts can be for instance manufactured as described in U.S. Pat. No. 5,072,040. It is desirable to purify the electrolyte salt to a purity level of at least about 99.0%, for example at least about 99.9%. Purification can be done using methods known in the art.

The electrolyte composition according to the invention further comprises at least one additional lithium compound selected from lithium boron compounds.

Said lithium compound is selected from lithium boron compounds, eventually from lithium oxalto borates in particular. It can advantageously be selected from lithium bis(oxalato)borate, lithium difluoro(oxalato)borate, lithium tetrafluoroborate, Li₂B₁₂F₁₂₋ₓHₓ wherein x is an integer ranging from 0 to 8, and mixtures thereof; more specifically, said lithium compound can be selected from lithium bis(oxalato)borate, lithium difluoro (oxalato)borate, lithium tetrafluoroborate, and mixtures thereof; in one embodiment, said lithium compound is lithium bis (oxalato)borate.

Optionally, the electrolyte composition according to the invention may further comprise at least one additional lithium compound selected from lithium phosphates compounds, lithium sulfonates compounds, and mixtures thereof.

According to one embodiment, said lithium compound is selected from lithium phosphates compounds. It can advantageously be selected from lithium monofluorophosphate, lithium difluorophosphate, lithium trifluoromethane phosphate, lithium tetrafluoro phosphate, lithium difluorobis(oxalato)phosphate, lithium tetrafluoro(oxalato)phosphate, lithium tris(oxalato)phosphate and mixtures thereof;

According to a sub-embodiment, said lithium compound is selected from fluorinated lithium phosphates compounds. It can especially be selected from lithium monofluorophosphate, lithium difluorophosphate, lithium trifluoromethane phosphate, lithium tetrafluoro phosphate and mixtures thereof; in one embodiment, said lithium compound is lithium difluorophosphate.

According to another sub-embodiment, said lithium compound is selected from lithium oxalato phosphates compounds, eventually from fluorinated oxalato phosphates compounds in particular. It can especially be selected from lithium difluorobis(oxalato)phosphate, lithium tetrafluoro(oxalato)phosphate, lithium tris(oxalato)phosphate and mixtures thereof; more specifically, it can be selected from difluorobis(oxalato)phosphate, lithium tetrafluoro(oxalato)phosphate or mixtures thereof.

According to one embodiment, said lithium compound is selected from lithium sulfonates. It can advantageously be selected from lithium fluorosulfonate, lithium trifluoromethanesulfonate or mixtures thereof.

According to a particular embodiment, said lithium compound is selected from lithium difluorophosphate, lithium bis(oxalato)borate and mixtures thereof.

Lithium compounds are commercially available (they can be purchased from a specialty chemical company such as Sigma-Aldrich) or can be prepared using methods known in the art. Lithium bis (oxalato)borate can be, for instance, synthesized as described in DE19829030. Lithium difluorophosphate can be for instance synthesized such as described in U.S. Pat. No. 8,889,091. It is desirable to purify the lithium compound to a purity level of at least about 99.0%, for example at least about 99.9%. Purification can be done using methods known in the art.

The lithium boron compound is present in the electrolyte composition of the invention in an amount ranging from 0.1% to 5%, preferably from 0.2% to 4%, more preferably from 0.3% to 3%, more preferably from 0.4% to 2%, even more preferably from 0.5% to 1%, in weight relative to the total amount of electrolyte composition.

The electrolyte composition according to the invention further comprises at least one cyclic sulfur compound.

According to one embodiment, said cyclic sulfur compound is represented by the formula:

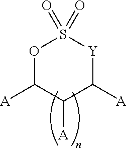

wherein Y is oxygen or denotes a HCA group; wherein each A is independently hydrogen or an optionally fluorinated ethenyl (H₂C═CH), allyl (H₂C═CH—CH₂), ethynyl (HC≡C—), propargyl (HC≡C—CH₂), or C₁-C₃ alkyl group; and n is 0 or 1.

The HCA group denotes a carbon atom that is linked to a hydrogen atom, a A entity as defined above, and adjacent sulfur and carbon atoms of the cyclic sulfur compound.

Each A entity may be unsubstituted or partially or totally fluorinated. Preferably, A is unsubstituted. More preferably, A is hydrogen or a C₁-C₃ alkyl group. Still more preferably, A is hydrogen.

In a sub-embodiment, Y is oxygen. In an alternative sub-embodiment, Y is CH₂. In a sub-embodiment n is 0. In an alternative sub-embodiment n is 1.

In a particular sub-embodiment, Y is oxygen and n=0. In an alternative particular sub-embodiment, Y is oxygen and n=1.

In a particular sub-embodiment, Y is CH₂ and n=0. In an alternative particular sub-embodiment, Y is CH₂ and n=1.

Mixtures of two or more of sulfur compounds may also be used.

The cyclic sulfur compound can be especially selected from 1,3,2-dioxathiolane-2,2-dioxide, 1,3,2-dioxathiolane-4-ethynyl-2,2-dioxide, 1,3,2-dioxathiolane-4-ethenyl-2,2-dioxide, 1,3,2-dioxathiolane-4,5-diethenyl-2,2-dioxide, 1,3,2-dioxathiolane-4-methyl-2,2-dioxide, 1,3,2-dioxathiolane-4,5-dimethyl-2,2-dioxide; 1,3,2-dioxathiane-2,2-dioxide, 1,3,2-dioxathiane-4-ethynyl-2,2-dioxide, 1,3,2-dioxathiane-5-ethynyl-2,2-dioxide, 1,3,2-dioxathiane-4-ethenyl-2,2-dioxide, 1,3,2-dioxathiane-5-ethenyl-2,2-dioxide, 1,3,2-dioxathiane-4,5-diethenyl-2,2-dioxide, 1,3,2-dioxathiane-4,6-diethenyl-2,2-dioxide, 1,3,2-dioxathiane-4,5,6-triethenyl-2,2-dioxide, 1,3,2-dioxathiane-4-methyl-2,2-dioxide, 1,3,2-dioxathiane-5-methyl-2,2-dioxide, 1,3,2-dioxathiane-4,5-dimethyl-2,2-dioxide, dioxathiane-4,6-dimethyl-2,2-dioxide, dioxathiane-4,5,6-trimethyl-2,2-dioxide; 1,3-propane sultone, 3-fluoro-1,3-propane sultone, 4-fluoro-1,3-propane sultone, 5-fluoro-1,3-propane sultone, 1,4-butane sultone, 3-fluoro-1,4-butane sultone, 4-fluoro-1,4-butane sultone, 5-fluoro-1,4-butane sultone, 6-fluoro-1,4-butane sultone and mixtures thereof.

In a first sub-embodiment, the cyclic sulfur compound is a cyclic sulfate selected from 1,3,2-dioxathiolane-2,2-dioxide, 1,3,2-dioxathiolane-4-ethynyl-2,2-dioxide, 1,3,2-dioxathiolane-4-ethenyl-2,2-dioxide, 1,3,2-dioxathiolane-4,5-diethenyl-2,2-dioxide, 1,3,2-dioxathiolane-4-methyl-2,2-dioxide, 1,3,2-dioxathiolane-4,5-dimethyl-2,2-dioxide; 1,3,2-dioxathiane-2,2-dioxide, 1,3,2-dioxathiane-4-ethynyl-2,2-dioxide, 1,3,2-dioxathiane-5-ethynyl-2,2-dioxide, 1,3,2-dioxathiane-4-ethenyl-2,2-dioxide, 1,3,2-dioxathiane-5-ethenyl-2,2-dioxide, 1,3,2-dioxathiane-4,5-diethenyl-2,2-dioxide, 1,3,2-dioxathiane-4,6-diethenyl-2,2-dioxide, 1,3,2-dioxathiane-4,5,6-triethenyl-2,2-dioxide, 1,3,2-dioxathiane-4-methyl-2,2-dioxide, 1,3,2-dioxathiane-5-methyl-2,2-dioxide, 1,3,2-dioxathiane-4,5-dimethyl-2,2-dioxide, dioxathiane-4,6-dimethyl-2,2-dioxide, dioxathiane-4,5,6-trimethyl-2,2-dioxide; and mixtures thereof;

More particularly, the cyclic sulfate can be selected from 1,3,2-dioxathiolane-2,2-dioxide, 1,3,2-dioxathiolane-4-ethynyl-2,2-dioxide, 1,3,2-dioxathiolane-4-ethenyl-2,2-dioxide, 1,3,2-dioxathiolane-4,5-diethenyl-2,2-dioxide, 1,3,2-dioxathiolane-4-methyl-2,2-dioxide, 1,3,2-dioxathiolane-4,5-dimethyl-2,2-dioxide; and mixtures thereof; being preferably 1,3,2-dioxathiolane-2,2-dioxide.

Alternatively, the cyclic sulfate can be selected from 1,3,2-dioxathiane-2,2-dioxide, 1,3,2-dioxathiane-4-ethynyl-2,2-dioxide, 1,3,2-dioxathiane-5-ethynyl-2,2-dioxide, 1,3,2-dioxathiane-4-ethenyl-2,2-dioxide, 1,3,2-dioxathiane-5-ethenyl-2,2-dioxide, 1,3,2-dioxathiane-4,5-diethenyl-2,2-dioxide, 1,3,2-dioxathiane-4,6-diethenyl-2,2-dioxide, 1,3,2-dioxathiane-4,5,6-triethenyl-2,2-dioxide, 1,3,2-dioxathiane-4-methyl-2,2-dioxide, 1,3,2-dioxathiane-5-methyl-2,2-dioxide, 1,3,2-dioxathiane-4,5-dimethyl-2,2-dioxide, dioxathiane-4,6-dimethyl-2,2-dioxide, dioxathiane-4,5,6-trimethyl-2,2-dioxide; and mixtures thereof; being preferably 1,3,2-dioxathiane-2,2-dioxide.

In a second sub-embodiment, the cyclic sulfur compound is a sultone selected from 1,3-propane sultone, 3-fluoro-1,3-propane sultone, 4-fluoro-1,3-propane sultone, 5-fluoro-1,3-propane sultone, 1,4-butane sultone, 3-fluoro-1,4-butane sultone, 4-fluoro-1,4-butane sultone, 5-fluoro-1,4-butane sultone, 6-fluoro-1,4-butane sultone and mixtures thereof.

More particularly, the sultone can be selected from 1,3-propane sultone, 3-fluoro-1,3-propane sultone, 4-fluoro-1,3-propane sultone, 5-fluoro-1,3-propane sultone and mixtures thereof; preferably from 1,3-propane sultone and/or 3-fluoro-1,3-propane sultone; being more preferably 1,3-propane sultone.

Alternatively, the sultone can be selected from 1,4-butane sultone, 3-fluoro-1,4-butane sultone, 4-fluoro-1,4-butane sultone, 5-fluoro-1,4-butane sultone, 6-fluoro-1,4-butane sultone and mixtures thereof; preferably from 1,4-butane sultone and/or 3-fluoro-1,4-butane sultone; being more preferably 1,4-butane sultone.

Cyclic sulfur compounds are commercially available (for instance they can be purchased from a specialty chemical company such as Sigma-Aldrich) or can be prepared using methods known in the art. It is desirable to purify the cyclic sulfur compound to a purity level of at least about 99.0%, for example at least about 99.9%. Purification can be done using methods known in the art.

The cyclic sulfur compound is present in the electrolyte composition in an amount ranging from 0.2% to 10%, preferably from 0.3% to 7%, more preferably from 0.4% to 5%, more preferably from 0.5% to 3%, in weight relative to the total amount of electrolyte composition.

The electrolyte composition according to the present invention can advantageously comprise at least one cyclic carboxylic acid anhydride.

In an embodiment, the cyclic carboxylic acid anhydride is represented by one of the formulas (IV) through (XI):

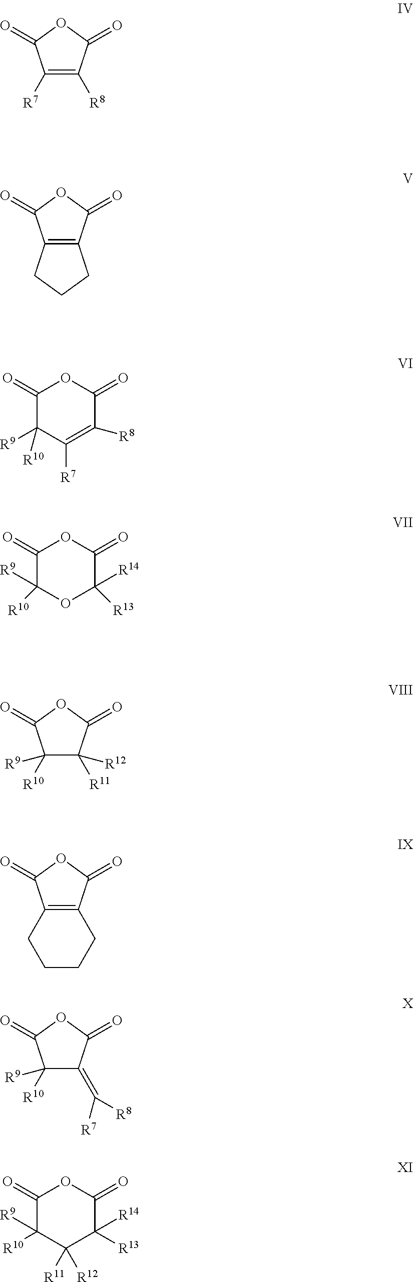

wherein R⁷ to R¹⁴ is each independently hydrogen, fluorine, a linear or branched C1 to C10 alkyl group optionally substituted with fluorine, an alkoxy, and/or a thioalkyl group, a linear or branched C2 to C10 alkenyl group, or a C6 to C10 aryl group.

The alkoxy group can have from one to ten carbons and can be linear or branched; examples of alkoxy groups include —OCH3, —OCH2CH3 and —OCH2CH2CH3.

The thioalkyl group can have from one to ten carbons and can be linear or branched; examples of thioalkyl substituents include —SCH3, —SCH2CH3, and —SCH2CH2CH3.

In a sub-embodiment, R⁷ to R¹⁴ is each independently hydrogen, fluorine or a C1 to C3 alkyl group, being preferably hydrogen.

In a sub-embodiment, said at least one cyclic carboxylic acid anhydride is of formula (IV) above.

Said at least one cyclic carboxylic acid anhydride can be especially selected from maleic anhydride; succinic anhydride; glutaric anhydride; 2,3-dimethylmaleic anhydride; citraconic anhydride; 1-cyclopentene-1,2-dicarboxylic anhydride; 2,3-diphenylmaleic anhydride; 3,4,5,6-tetrahydrophthalic anhydride; 2,3-dihydro-1,4-dithiiono-[2,3-c]furan-5,7-dione; phenylmaleic anhydride; and mixtures thereof.

Preferably, said at least one cyclic carboxylic acid anhydride is selected from maleic anhydride, succinic anhydride, glutaric anhydride, 2,3-dimethylmaleic anhydride, citraconic anhydride, or mixtures thereof.

Still preferably, said at least one cyclic carboxylic acid anhydride is maleic anhydride.

Cyclic carboxylic acid anhydrides can be purchased from a specialty chemical company (such as Sigma-Aldrich) or prepared using methods known in the art. For instance, maleic anhydride can be synthesized as described in U.S. Pat. No. 3,907,834. It is desirable to purify the cyclic carboxylic acid anhydride to a purity level of at least about 99.0%, for example at least about 99.9%. Purification can be done using methods known in the art.

The cyclic carboxylic acid anhydride is usually present in the electrolyte composition in an amount ranging from 0.10% to 5%, preferably from 0.15% to 4%, more preferably from 0.20% to 3%, more preferably from 0.25% to 1%, even more preferably from 0.30% to 0.80%, in weight relative to the total amount of electrolyte composition.

According to an embodiment, the electrolyte composition of the invention consists of a solvent, one or more additives and an electrolyte salt.

The solvent can advantageously consist of at least one, preferably at least two, cyclic carbonate(s) and at least one fluorinated acyclic carboxylic acid ester. In a sub-embodiment, the solvent consists of at least one non-fluorinated cyclic carbonate, at least one fluorinated carbonate and at least one fluorinated acyclic carboxylic acid ester, each being such as described above.

Said additives can advantageously comprise or consist of at least a lithium compound, a cyclic sulfur compound and optionally a cyclic carboxylic acid anhydride, each being such as described above.

The electrolyte salt can advantageously consist of one or more lithium salts, such as described above.

According to one embodiment, the electrolyte composition comprises at least one, at least two or any combinations of the following features (all percentages being expressed by weight relative to the total weight of the electrolyte composition):
from 5% to 17% of a non-fluorinated cyclic carbonate selected from ethylene carbonate, propylene carbonate, vinyl ethylene carbonate and mixtures thereof;
from 0.5% to 10%, preferably from 2% to 10%, more preferably from 3% to 10% of 4-fluoro-1,3-dioxolan-2-one;
from 70% to 95% of a fluorinated acyclic carboxylic acid ester selected from 2,2-difluoroethyl acetate, 2,2-difluoroethyl propionate, 2,2,2-trifluoroethyl acetate, 2,2-difluoroethyl formate and mixtures thereof;
from 5% to 20%, preferably from 9% to 16%, more preferably from 11% to 16%, of an electrolyte salt selected from lithium hexafluorophosphate, lithium bis(fluorosulfonyl)imide, lithium bis(trifluoromethanesulfonyl)imide and mixtures thereof;
from 0.1% to 5%, preferably from 0.4% to 2%, more preferably from 0.5% to 1% of lithium bis(oxalato)borate;
from 0.2% to 10%, preferably from 0.4% to 5%, more preferably from 0.5% to 3% of a cyclic sulfur compound selected from 1,3,2-dioxathiolane-2,2-dioxide, 1,3,2-dioxathiane-2,2-dioxide, 1,3-propane sultone and mixtures thereof;
from 0.10% to 5%, preferably from 0.25% to 1%, more preferably from 0.30% to 0.80% of a cyclic carboxylic acid anhydride selected from maleic anhydride, succinic anhydride, glutaric anhydride, 2,3-dimethylmaleic anhydride, citraconic anhydride and mixtures thereof.

It is demonstrated in the examples provided hereunder that the electrolyte composition according to the invention is especially suitable for a NMC and/or LCO battery, advantageously one operating at high voltage.

The cycle life of a high voltage battery comprising the electrolyte composition according to the invention at room temperature or at higher temperatures (i.e. at least at 40° C., for instance at 45° C.) is significantly improved at high voltage.

Additionally, it is demonstrated that the electrolyte composition according to the invention, containing remarkably high amounts of fluorinated acyclic carboxylic acid ester and low amounts of non-fluorinated cyclic carbonate, shows an advantageously long cycle life at high temperature.

The lithium secondary battery comprising the electrolyte composition according to the invention demonstrates remarkable safety properties at a high voltage and high temperatures.

These effects allow a safe use of the electrolyte composition in a high voltage battery.

The disclosure of all patent applications, and publications cited herein are hereby incorporated by reference, to the extent that they provide exemplary, procedural or other details supplementary to those set forth herein. Should the disclosure of any of the patents, patent applications, and publications that are incorporated herein by reference conflict with the present specification to the extent that it might render a term unclear, the present specification shall take precedence.

Each and every claim is incorporated into the specification as an embodiment of the present invention. Thus, the claims are a further description and are an addition to the preferred embodiments of the present invention.

The invention is further illustrated by the following examples:

### EXAMPLES

### Examples According to Prior Art 1 to 8

### Preparation of the Electrolyte Compositions

The compositions to be tested are prepared by simple mix of their ingredients by using a magnetic stirrer: the ingredients are added one by one in a bottle, starting with the solvents, then the electrolyte salt and then the additives. The mix is gently agitated until the composition becomes transparent. The content of each composition is indicated in table 1 below. The following ingredients, supplied by the specified companies, are used.
LiPF₆: Lithium hexafluorophosphate (Enchem)
EC: Ethylene carbonate (Enchem)
FEC: Monofluoroethylene carbonate (Enchem)
PC: Propylene carbonate (Enchem)
DFEA: 2,2-Difluoroethyl Acetate (Solvay)
LiBOB: Lithium bis(oxalate)borate (Enchem)
ESa: 1,3,2-Dioxathiolane 2,2-dioxide (Enchem)
MA: Maleic anhydride (Enchem)
PS: 1,3-Propanesultone (Enchem)
PRS: 1,3-Propenesultone (Enchem)
PES: 1,3,2-Dioxathiane 2,2-Dioxide (Enchem)
PP: Propyl propionate (Enchem)
SN: Succinonitrile (Enchem)
VC: Vinylene carbonate (Enchem)
VEC: Vinylethylene carbonate (Enchem)
DEC: Diethyl carbonate (Enchem)
EMC: Ethyl methyl carbonate (Enchem)

TABLE 1
Electrolyte Compositions tested

| | Salt | Solvent | Additives |
|---|---|---|---|
| # | (wt %)¹ | (wt %)¹ | (wt %)¹ |
| EX1 | LiPF₆ | FEC (3.43%) PC (18.01%) | LIBOB (0.85%) |
| | (11.37%) | DFEA (64.34%) | ESa (1.5%) MA (0.5%) |
| EX2 | LiPF₆ | FEC (3.43%) PC (18.01%) | LIBOB (0.85%) |
| | (11.37%) | DFEA (64.34%) | PES (1.5%) MA (0.5%) |
| EX3 | LiPF₆ | FEC (3.43%) PC (18.01%) | LIBOB (0.85%) |
| | (11.37%) | DFEA (64.34%) | PS (1.5%) MA (0.5%) |
| CE1 | LiPF₆ | EC (22.27%) PC (7.42%) | VC (2%) FEC (3%) |
| | (12.78%) | PP (44.53%) | PS (3%) SN (5%) |
| CE2 | LiPF₆ | EC (31.39%) DEC (53.45%) | VC (2%) SN (0.5%) |
| | (12.66%) | | |
| CE3 | LiPF₆ | EC (33.86%) DEC (24.85%) | VC (1%) VEC (1%) |
| | (12.34%) | EMC (25.95%) | PRS (1%) |

¹expressed in weight percent relative to the total weight of the composition

### Preparation of a LCO Cathode Active Material Powder

A cobalt precursor Co₃O₄, of which the average particle size (measured using a Malvern Mastersizer 3000 with Hydro MV wet dispersion accessory after dispersing the powder in an aqueous medium) is around 2.8 μm, is mixed with a lithium precursor such as Li₂CO₃, and MgO and Al₂O₃ as dopants in a typical industrial blender to prepare “Blend-1”, wherein the molar ratio between Li and Co (Li/Co) is 1.05 to 1.10, Mg/Co is 0.01, and Al/Co is 0.01. The Blend-1 in ceramic trays is fired at 900° C. to 1100° C. for 5 to 15 hours in a kiln. The first sintered powder is de-agglomerated and screened by a milling equipment and sieving tool to prepare a doped intermediate LCO named “LCO-1”. The Li/Co of LCO-1 from ICP analysis is 1.068. The LCO-1 is mixed with a mixed metal hydroxide (M′(OH)₂, M′=Ni_{0.55}Mn_{0.30}Co_{0.15}) of which the average particle size (measured using a Malvern Mastersizer 3000 with Hydro MV wet dispersion accessory after dispersing the powder in an aqueous medium) is around 3 μm by a typical industrial blender to prepare “Blend-2”, wherein the amount of M′(OH)₂ is 5 mol % compared to the cobalt in LCO-1 (M7Co_{Lco-1}=0.05). M′(OH)₂ is prepared by typical co-precipitation technology. The Blend-2 in ceramic trays is fired at 900° C. to 1100° C. for 5 to 15 hours in a kiln. The second sintered powder is de-agglomerated and screened by a milling equipment and sieving tool to prepare a final Mn bearing doped LCO named “CAT1” (LiM₁O₂, wherein M₁=Co_{0.937}Ni_{0.028}Mn_{0.015}Al_{0.01}Mg_{0.01}). In CAT1, the ratio Li:M₁ may be equal to (1−x):(1+x) wherein −0.005≤x≤0 or 0≤x≤0.005.

### Preparation of the LCO Full Cells

200 mAh pouch-type batteries are prepared as follows: the LCO positive electrode material powder obtained as described above, Super-P (Super-P Li commercially available from Timcal), and graphite (KS-6 commercially available from Timcal) as positive electrode conductive agents and polyvinylidene fluoride (PVdF 1700 commercially available from Kureha) as a positive electrode binder are added to NMP (N-methyl-2-pyrrolidone) as a dispersion medium. The mass ratio of the positive electrode material powder, conductive agent, and binder is set at 96/2/2. Thereafter, the mixture is kneaded to prepare a positive electrode mixture slurry. The resulting positive electrode mixture slurry is then applied onto both sides of a positive electrode current collector, made of a 12 μm thick aluminum foil. The positive electrode active material loading weight is around 13 mg/cm². The electrode is then dried and calendared using a pressure of 120 Kgf. The typical electrode density is 4 g/cm³. In addition, an aluminum plate serving as a positive electrode current collector tab is arc-welded to an end portion of the positive electrode.

Commercially available negative electrodes are used. In short, a mixture of graphite, CMC (carboxy-methyl-cellulose-sodium) and SBR (styrenebutadiene-rubber), in a mass ratio of 96/2/2, is applied on both sides of a copper foil. A nickel plate serving as a negative electrode current collector tab is arc-welded to an end portion of the negative electrode.

A sheet of the positive electrode, a sheet of the negative electrode, and a sheet of a conventional separator (e.g. a ceramic coated separator with a thickness of 20 μm and having a porosity superior or equal to 50% and inferior or equal to 70%; preferably of 60%) interposed between them are spirally wound using a winding core rod in order to obtain a spirally-wound electrode assembly. The wounded electrode assembly and the electrolyte are then put in an aluminum laminated pouch in an air-dry room with dew point of −50° C., so that a flat pouch-type lithium secondary battery is prepared. The design capacity of the secondary battery is around 200 mAh when charged to 4.35V.

Each electrolyte composition (EX1, EX2, EX3, CE1, CE2) is injected into a LCO dry cell obtained by the above described method by using a pipette; the cells are put in a vacuum container for wetting, then vacuum is released and the cells are left for 8 hours at room temperature for further wetting. The cells are sealed by using a vacuum sealing machine. The complete pouch cells are aged one day at room temperature (first aging). Each battery is pre-charged at 30% of its theoretical capacity and aged one day at room temperature (second aging). The batteries are then degassed and the aluminum pouches are re-sealed.

### Preparation of a NMC Cathode Active Material Powder

The following description illustrates the manufacturing procedure of high Ni-excess NMC powders through a double sintering process which is a solid state reaction between a lithium source, usually Li₂CO₃ or LiOH.H₂O, and a mixed transition metal source, usually a mixed transition metal hydroxide M′(OH)₂ or oxyhydroxide M′OOH (with M′=Ni, Mn and Co), but not limited to these hydroxides. The double sintering process includes amongst others two sintering steps:

1) 1^{st} blending: to obtain a lithium deficient sintered precursor, the lithium and the mixed transition metal sources are homogenously blended in a Henschel Mixer® for 30 mins.
2) 1^{st} sintering: the blend from the 1^{st} blending step is sintered at 700 to 950° C. for 5-30 hours under an oxygen containing atmosphere in a furnace. After the 1^{st} sintering, the sintered cake is crushed, classified and sieved so as to ready it for the 2^{nd} blending step. The product obtained from this step is a lithium deficient sintered precursor, meaning that the Li/M′ stoichiometric ratio in LiM′O₂ is less than 1.
3) 2^{nd} blending: the lithium deficient sintered precursor is blended with LiOH.H₂O in order to correct the Li stoichiometry. The blending is performed in a Henschel Mixer® for 30 mins.
4) 2^{nd} sintering: the blend from the 2^{nd} blending is sintered in the range of 800 to 950° C. for 5-30 hours under an oxygen containing atmosphere in a furnace. 5) Post treatment: after the 2^{nd} sintering, the sintered cake is crushed, classified and sieved so as to obtain a non-agglomerated NMC powder.

The NMC active material used in the cells of the examples 6 to 8 below is prepared according to this manufacturing method. A mixed nickel-manganese-cobalt hydroxide (M′(OH)₂) is used as a precursor, where M′(OH)₂ is prepared by a co-precipitation process in a large-scale continuous stirred tank reactor (CSTR) with mixed nickel-manganese-cobalt sulfates, sodium hydroxide and ammonia. In the 1^{st} blending step, 5.5 kg of the mixture of M′(OH)₂, wherein M′=Ni_{0.625}Mn_{0.175}Co_{0.20} (Ni excess=0.45), and LiOH.H₂O with Li/M′ ratio of 0.85 is prepared. The 1^{st} blend is sintered at 800° C. for 10 hours under an oxygen atmosphere in a chamber furnace. The resultant lithium deficient sintered precursor is blended with LiOH.H₂O in order to prepare 50 g of the 2^{nd} blend of which Li/M′ is 1.01. The 2^{nd} blend is sintered at 840° C. for 10 hours under the dry air atmosphere in a chamber furnace. The above prepared EX1.1 has the formula Li_{1.005}M′_{0.995}O₂ (Li/M′=1.01).

### Preparation of the NMC Full Cells

150 mAh pouch-type cells are prepared as follows: the NMC cathode material obtained according to the above method, Super-P (Super-PTM Li commercially available from Timcal), graphite (KS-6 commercially available from Timcal) as positive electrode conductive agents and polyvinylidene fluoride (PVDF 1710 commercially available from Kureha) as a positive electrode binder are added to N-methyl-2-pyrrolidone (NMP) as a dispersion medium so that the mass ratio of the positive electrode active material powder, the positive electrode conductive agents super P and graphite, and the positive electrode binder is set at 92/3/1/4. Thereafter, the mixture is kneaded to prepare a positive electrode mixture slurry. The resulting positive electrode mixture slurry is then applied onto both sides of a positive electrode current collector, made of a 15 μm thick aluminum foil. The width of the applied area is 43 mm and the length is 240 mm. Typical cathode active material loading weight is 13.9 mg/cm². The electrode is then dried and calendared using a pressure of 100 Kgf (981 N). Typical electrode density is 3.2 g/cm³. In addition, an aluminum plate serving as a positive electrode current collector tab is arc-welded to an end portion of the positive electrode.

Commercially available negative electrodes are used. In short, a mixture of graphite, carboxy-methyl-cellulose-sodium (CMC) and styrenebutadiene-rubber (SBR), in a mass ratio of 96/2/2, is applied on both sides of a copper foil. A nickel plate serving as a negative electrode current collector tab is arc-welded to an end portion of the negative electrode. Typical cathode and anode discharge capacity ratio used for cell balancing is 0.80.

A sheet of the positive electrode, a sheet of the negative electrode, and a sheet of separator made of a 20 μm-thick microporous polymer film (Celgard® 2320 commercially available from Celgard) interposed between them are spirally wound using a winding core rod in order to obtain a spirally-wound electrode assembly. The assembly and the electrolyte are then put in an aluminum laminated pouch in an air-dry room with dew point of −50° C., so that a flat pouch-type lithium secondary battery is prepared. The design capacity of the secondary battery is 150 mAh when charged to 4.20V.

Each electrolyte composition (EX1, EX2, CE3) is injected into a dry cell obtained by the above described method by using a pipette; the cells are put in a vacuum container for wetting, then vacuum is released and the cells are left for 8 hours at room temperature for further wetting. The cells are sealed by using a vacuum sealing machine. The complete pouch cells are aged one day at room temperature (first aging). Each battery is pre-charged at 30% of its theoretical capacity and aged one day at room temperature (second aging). The batteries are then degassed and the aluminum pouches are re-sealed.

### Testing Methods and Evaluation Criteria

### A) Cycle Life Test

200 mAh pouch-type LCO batteries prepared by above preparation method are charged and discharged several times under the following conditions, both at 25° C. and 45° C., to determine their charge-discharge cycle performance: charging is performed in CC mode under 1C rate up to 4.45V, then CV mode until C/20 is reached, the cell is then set to rest for 10 minutes, discharge is done in CC mode at 1C rate down to 3.0V, the cell is then set to rest for 10 minutes, the charge-discharge cycles proceed until the battery reaches 80% residual capacity.

150 mAh pouch-type NMC batteries prepared by above preparation method are charged and discharged several times under the following conditions, both at 25° C. and 45° C., to determine their charge-discharge cycle performance: charging is performed in CC mode under 1C rate up to 4.35V, then CV mode until C/20 is reached, the cell is then set to rest for 10 minutes, discharge is done in CC mode at 1C rate down to 2.7V, the cell is then set to rest for 10 minutes, the charge-discharge cycles proceed until the battery reaches 80% residual capacity.

Cycle life at 80% of relative capacity retention is the number of cycles needed to reach 80% of the maximum capacity achieved during cycling at 25° C. or 45° C. respectively.

### B) High Temperature Storage

The 200 mAh pouch-type LCO batteries prepared by the above preparation method are fully charged until 4.45V then stored at 60° C. for 2 weeks. Respectively, the 150 mAh pouch-type NCM batteries prepared by the above preparation method are fully charged until 4.35V then also stored at 60° C. for 2 weeks. The cells are then started in discharge at 1C at room temperature to measure the residual capacity (capacity after storage/capacity before storage). A full cycle at 1C (with CV) allows measuring the recovered capacity (capacity after storage/capacity before storage).

The internal resistance or direct current resistance (DCR) is measured by suitable pulse tests of the battery. DCR is measured by suitable pulse tests of the battery. The measurement of DCR is for example described in “Appendix G, H, I (page 2) and J of the USABC Electric Vehicle Battery Test Procedures” which can be found, for instance, at http://www.uscar.org. USABC stands for “US advanced battery consortium” and USCAR stands for “United States Council for Automotive Research”. The thickness variation is also measured ((thickness after storage-thickness before storage)/thickness before storage).

### Results

Table 2 shows that good performances in term of cycle life are obtained for the electrolyte compositions EX1, EX2 and EX3.

Moreover, the recovered capacities with electrolyte compositions EX1, EX2 and EX3 are better that with the other compositions (see table 3).

From the data provided in tables 2 and 3, it is clear that the use of an electrolyte composition according to the invention in a secondary battery cell allows achieving high performance while limiting the gas generation.

TABLE 2
Cycle life

| | | Positive | Cycles at 80% | Cycles at 80% |
|---|---|---|---|---|
| | | electrode | of relative | of relative |
| Example | Electrolyte | material | capacity (25° C.) | capacity (45° C.) |
| 1 | EX1 | LCO | >1000 | 795 |
| | | | (89.3% at 1000^{th}) | |
| 2 | EX2 | LCO | >1000 | 793 |
| | | | (88.7% at 1000^{th}) | |
| 3 | EX3 | LCO | >1000 | 726 |
| | | | (89.2% at 1000^{th}) | |
| 4 | CE1 | LCO | 91 | 70 |
| 5 | CE2 | LCO | 832 | 127 |
| 6 | EX1 | NMC | >1000 | >1000 |
| | | | (94.6% at 1000^{th}) | (87.8% at 1000^{th}) |
| 7 | EX2 | NMC | >1000 | >1000 |
| | | | (92.3% at 1000^{th}) | (84.6% at 1000^{th}) |
| 8 | CE3 | NMC | >1000 | 648 |
| | | | (88.9% at 1000^{th}) | |

TABLE 3
High temperature storage results after 2 weeks

| | | Positive | | |
|---|---|---|---|---|
| | | electrode | Recovered | Thickness |
| Example | Electrolyte | material | capacity (%) | change (%) |
| 1 | EX1 | LCO | 68.0 | 27.4 |
| 2 | EX2 | LCO | 75.7 | 27.7 |
| 3 | EX3 | LCO | 70.9 | 63.3 |
| 4 | CE1 | LCO | 0.0 | 4.3 |
| 5 | CE2 | LCO | 65.6 | 69.6 |
| 6 | EX1 | NMC | 95.0 | 1.76 |
| 7 | EX2 | NMC | 92.9 | 0.54 |
| 8 | CE3 | NMC | 95.9 | 13.9 |

### Examples 9 to 11

### Preparation of the Electrolyte Compositions

The compositions to be tested are prepared by simple mix of their ingredients by using a magnetic stirrer: the ingredients are added one by one in a bottle, starting with the solvents, then the electrolyte salt and then the additives. The mix is gently agitated until the composition becomes transparent. The content of each composition is indicated in table 3 below. The ingredients used are the same as the ingredients used in EX1, CE1, CE2 and CE3 herein above.

TABLE 3
Electrolyte Compositions tested

| | Salt | Solvent | Additives |
|---|---|---|---|
| # | (wt %)¹ | (wt %)¹ | (wt %)¹ |
| EX4 | LiPF₆ | FEC (3.38%) PC (8.45%) | LIBOB (0.85%) ESa (3.0%) |
| | (11.19%) | DFEA (72.63%) | MA (0.5%) |
| CE4 | LiPF₆ | FEC (3.38%) PC (17.74%) | LIBOB (0.85%) ESa (3.0%) |
| | (11.19%) | DFEA (63.34%) | MA (0.5%) |
| CE5 | LiPF₆ | FEC (3.38%) PC (17.74%) | LIBOB (0.85%) PES (3.0%) |
| | (11.19%) | DFEA (63.34%) | MA (0.5%) |

¹expressed in weight percent relative to the total weight of the composition

### Preparation of a LCO Cathode Active Material Powder

The same procedures to prepare a LCO cathode active material powder as described in examples 1 to 8 were used.

### Preparation of the LCO Full Cells

The same procedures to prepare LCO full cells as described in examples 1 to were used, except that 1600 mAh pouch-type batteries were prepared, using a 20 μm thick aluminum foil for 1600 mAh pouch-type batteries. The positive electrode active material loading weight was around 15 mg/cm². The design capacity of the secondary battery is around 1600 mAh when charged to 4.45V.

### Testing Methods and Evaluation Criteria—Cycle Life Test at 45° C.

Cells containing each electrolyte composition (EX4, CE4, CE5) are tested according to the same testing methods as described above.

### Results

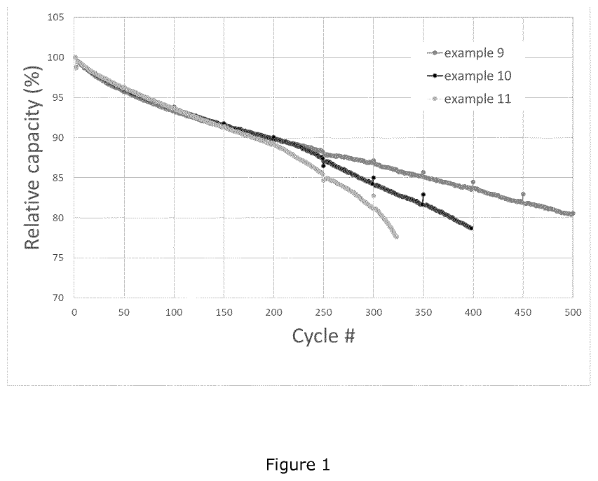

FIG. 1 shows the retention capacity (in %) of the cells containing the electrolyte compositions EX4, CE4 and CE4 as a function of the number of cycles. The number of cycles necessary to reach a retention capacity of 80% is reported in Table 4 below.

TABLE 4
Cycle life

| | | Positive | Number of cycles to reach a |
|---|---|---|---|
| | | electrode | retention capacity of 80% at |
| Example | Electrolyte | material | 45° C.) |
| 9 | EX4 | LCO | 500 |
| 10 | CE4 | LCO | 380 |
| 11 | CE5 | LCO | 310 |

From these data, it is clear that good performances in term of cycle life are obtained for the electrolyte composition EX4 vs. CE4 and CE5.

1. An electrolyte composition comprising:
a) from 5% to 17% of a non-fluorinated cyclic carbonate, and from 0.5% to 10% of a fluorinated cyclic carbonate,
b) from 70% to 95% of a fluorinated acyclic carboxylic acid ester,
c) at least one electrolyte salt,
d) from 0.1% to 5% of a lithium boron compound,
e) from 0.2% to 10% of a cyclic sulfur compound, and
f) optionally at least one cyclic carboxylic acid anhydride,
all percentages being expressed by weight relative to the total weight of the electrolyte composition.

2. The electrolyte composition according to claim 1, wherein the non-fluorinated cyclic carbonate is of formula (I) or (II) 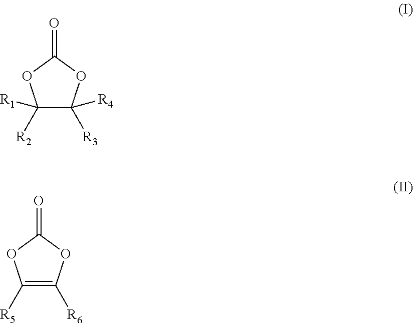
wherein R₁ to R₆ are independently selected from hydrogen, C₁ to C₃-alkyl, C₂ to C₃-alkenyl, or C₂ to C₃-alkynyl groups.

3. The electrolyte composition according to claim 2, wherein the non-fluorinated cyclic carbonate is selected from the group consisting of ethylene carbonate, propylene carbonate, vinylene carbonate, ethyl propyl vinylene carbonate, vinyl ethylene carbonate, dimethylvinylene carbonate, and mixtures thereof.

4. The electrolyte composition according to claim 1, wherein the fluorinated cyclic carbonate is of formula (I) or (II) 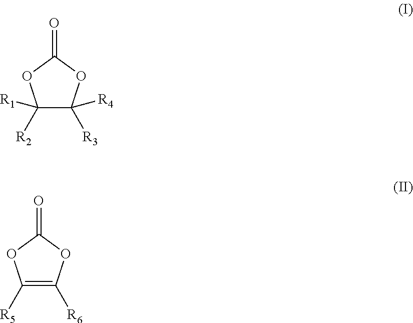
wherein at least one of R₁ to R₆ is fluorine or a C₁ to C₃-fluoroalkyl, C₂ to C₃-fluoroalkenyl, C₂ to C₃-fluoroalkynyl group.

5. The electrolyte composition according to claim 4, wherein the fluorinated cyclic carbonate is selected from the group consisting of 4-fluoro-1,3-dioxolan-2-one; 4-fluoro-4-methyl-1,3-dioxolan-2-one; 4-fluoro-5-methyl-1,3-dioxolan-2-one; 4-fluoro-4,5-dimethyl-1,3-dioxolan-2-one; 4,5-difluoro-1,3-dioxolan-2-one; 4,5-difluoro-4-methyl-1,3-dioxolan-2-one; 4,5-difluoro-4,5-dimethyl-1,3-dioxolan-2-one; 4,4-difluoro-1,3-dioxolan-2-one; 4,4,5-trifluoro-1,3-dioxolan-2-one; 4,4,5,5-tetrafluoro-1,3-dioxolan-2-one; and mixtures thereof.

6. The electrolyte composition according to claim 4, wherein the fluorinated cyclic carbonate is present in the electrolyte composition in an amount ranging from 0.8% to 10%, by weight relative to the total weight of the electrolyte composition.

7. The electrolyte composition according to claim 1, wherein the fluorinated acyclic carboxylic acid ester is represented by the formula:
R¹—COO—R²
wherein
i) R¹ is H, an alkyl group, or a fluoroalkyl group;
ii) R² is an alkyl group, or a fluoroalkyl group;
iii) either or both of R¹ and R² comprises fluorine; and
iv) R¹ and R², taken as a pair, comprise at least two carbon atoms but not more than seven carbon atoms.

8. The electrolyte composition according to claim 7, wherein the fluorinated acyclic carboxylic acid ester is selected from the group consisting of 2,2-difluoroethyl acetate, 2,2,2-trifluoroethyl acetate, 2,2-difluoroethyl propionate, 3,3-difluoropropyl acetate, 3,3-difluoropropyl propionate, methyl 3,3-difluoropropanoate, ethyl 3,3-difluoropropanoate, ethyl 4,4-difluorobutanoate, difluoroethyl formate, trifluoroethyl formate, and mixtures thereof.

9. The electrolyte composition according to anyone of claims 1 to 8 claim 1, wherein the electrolyte salt is a lithium salt.

10. The electrolyte composition according to claim 1, wherein the electrolyte salt is present in the electrolyte composition in an amount ranging from 5% to 20%, by weight relative to the total weight of the electrolyte composition.

11. The electrolyte composition according to claim 1, wherein said lithium boron compound is selected from the group consisting of lithium tetrafluoroborate, lithium bis(oxalato)borate, lithium difluoro(oxalato)borate, and Li₂B₁₂F₁₂₋ₓHₓ wherein x is an integer ranging from 0 to 8.

12. The electrolyte composition according to claim 1, wherein the lithium boron compound is present in the electrolyte composition in an amount ranging from 0.2% to 4%, by weight relative to the total weight of the electrolyte composition.

13. The electrolyte composition according to claim 1, wherein the cyclic sulfur compound is represented by the formula: 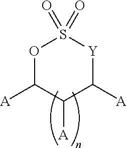
wherein Y is oxygen or denotes an HCA group; wherein each A is independently hydrogen or an optionally fluorinated ethenyl, allyl, ethynyl, propargyl, or C₁-C₃ alkyl group; and n is 0 or 1.

14. The electrolyte composition according to claim 13, wherein the cyclic sulfur compound is selected from 1,3,2-dioxathiolane-2,2-dioxide, 1,3,2-dioxathiolane-4-ethynyl-2,2-dioxide, 1,3,2-dioxathiolane-4-ethenyl-2,2-dioxide, 1,3,2-dioxathiolane-4,5-diethenyl-2,2-dioxide, 1,3,2-dioxathiolane-4-methyl-2,2-dioxide, 1,3,2-dioxathiolane-4,5-dimethyl-2,2-dioxide; 1,3,2-dioxathiane-2,2-dioxide, 1,3,2-dioxathiane-4-ethynyl-2,2-dioxide, 1,3,2-dioxathiane-5-ethynyl-2,2-dioxide, 1,3,2-dioxathiane-4-ethenyl-2,2-dioxide, 1,3,2-dioxathiane-5-ethenyl-2,2-dioxide, 1,3,2-dioxathiane-4,5-diethenyl-2,2-dioxide, 1,3,2-dioxathiane-4,6-diethenyl-2,2-dioxide, 1,3,2-dioxathiane-4,5,6-triethenyl-2,2-dioxide, 1,3,2-dioxathiane-4-methyl-2,2-dioxide, 1,3,2-dioxathiane-5-methyl-2,2-dioxide, 1,3,2-dioxathiane-4,5-dimethyl-2,2-dioxide, dioxathiane-4,6-dimethyl-2,2-dioxide, dioxathiane-4,5,6-trimethyl-2,2-dioxide; 1,3-propane sultone, 3-fluoro-1,3-propane sultone, 4-fluoro-1,3-propane sultone, 5-fluoro-1,3-propane sultone, 1,4-butane sultone, 3-fluoro-1,4-butane sultone, 4-fluoro-1,4-butane sultone, 5-fluoro-1,4-butane sultone, 6-fluoro-1,4-butane sultone and mixtures thereof.

15. The electrolyte composition according to claim 1, wherein the cyclic sulfur compound is present in the electrolyte composition in an amount ranging from 0.3% to 7%, by weight relative to the total weight of the electrolyte composition.

16. The electrolyte composition according to claim 1, wherein the cyclic carboxylic acid anhydride is represented by one of the formulas (IV) through (XI): 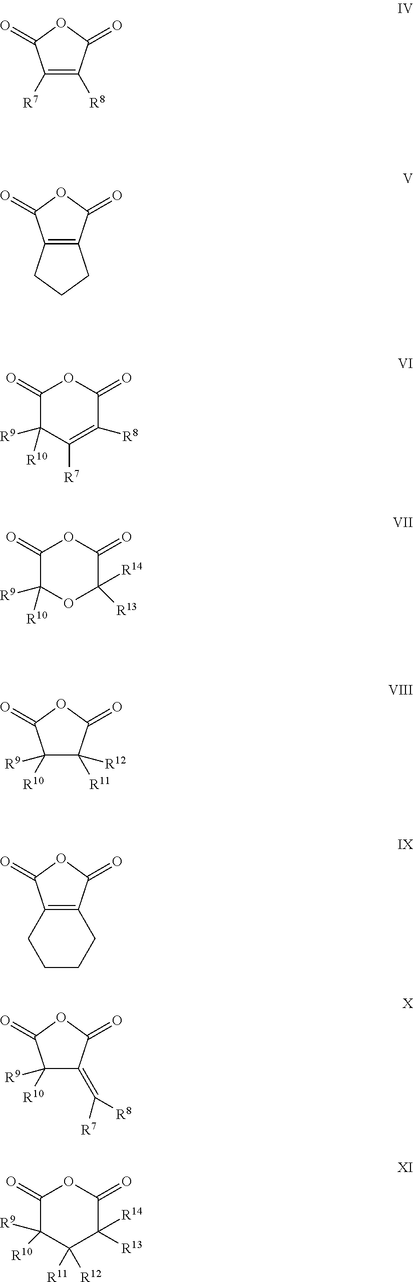
wherein R⁷ to R¹⁴ is each independently hydrogen, fluorine, a linear or branched C₁ to C₁₀ alkyl group optionally substituted with fluorine, alkoxy, and/or thioalkyl substituents, a linear or branched C₂ to C₁₀ alkenyl group, or a C₆ to C₁₀ aryl group.

17. The electrolyte composition according to claim 16, wherein the cyclic carboxylic acid anhydride is selected from the group consisting of maleic anhydride; succinic anhydride; glutaric anhydride; 2,3-dimethylmaleic anhydride; citraconic anhydride; 1-cyclopentene-1,2-dicarboxylic anhydride; 2,3-diphenylmaleic anhydride; 3,4,5,6-tetrahydrophthalic anhydride; 2,3-dihydro-1,4-dithiiono-[2,3-c]furan-5,7-dione; phenylmaleic anhydride; and mixtures thereof.

18. The electrolyte composition according to claim 1, wherein the cyclic carboxylic acid anhydride is present in the electrolyte composition in an amount ranging from 0.10% to 5%, by weight relative to the total weight of the electrolyte composition.

19. The electrolyte composition according to claim 9, wherein the electrolyte salt is selected from the group consisting of hexafluorophosphate (LiPF₆), lithium bis(trifluromethyl)tetrafluorophosphate (LiPF₄(CF₃)₂), lithium bis(pentafluoroethyl)tetrafluorophosphate (LiPF₄(C₂F₅)₂), lithium tris(pentafluoroethyl)trifluorophosphate (LiPF₃(C₂F₅)₃), lithium bis(trifluoromethanesulfonyl)imide (LiN(CF₃SO₂)₂), lithium bis(perfluoroethanesulfonyl)imide LiN(C₂F₅ SO₂)₂, LiN(C₂F₅SO₃)₂, lithium (fluorosulfonyl) (nonafluorobutanesulfonyl)imide, lithium bis(fluorosulfonyl)imide, lithium tetrafluoroborate, lithium perchlorate, lithium hexafluoroarsenate, lithium hexafluoroantimonate, lithium tetrachloroaluminate, LiAlO₄, lithium trifluoromethanesulfonate, lithium nonafluorobutanesulfonate, lithium tris(trifluoromethanesulfonyl)methide, lithium bis(oxalato)borate, lithium difluoro(oxalato)borate, Li₂B₁₂F₁₂₋ₓHₓ where x is an integer equal to 0 to 8, and mixtures of lithium fluoride and anion receptors.

20. The electrolyte composition according to claim 14, wherein the cyclic sulfur compound is selected from the group consisting of 1,3,2-dioxathiolane-2,2-dioxide, 1,3,2-dioxathiane-2,2-dioxide and 1,3-propane sultone.
